(19) United States
(12) Patent Application Publication
(10) Pub. No.: US 2016/0361828 A1
(43) Pub. Date: Dec. 15, 2016

(54) RAZOR BLADE STEEL

(71) Applicant: The Gillette Company, Boston, MA (US)

(72) Inventors: Ming Laura Xu, Natick, MA (US); Charles Samuel White, Lynnfield, MA (US); Norihide Fukuzawa, Yasugi (JP); Tomonori Ueno, Yasugi (JP)

(21) Appl. No.: 14/737,074

(22) Filed: Jun. 11, 2015

(51) Int. Cl. B26B 21/58; B26B 21/22; C22C 38/02; C21D 9/00; C22C 38/22; C22C 38/04; B21D 53/64; C21D 8/00

(52) U.S. Cl. CPC B26B 21/58; B21D 53/645; B26B 21/222; C21D 8/005; C21D 9/0068; C22C 38/22; C22C 38/04; C22C 38/02

(57) ABSTRACT

The present invention provides a razor blade steel and method of forming a razor blade from a steel which has a high hardness but is also ductile after being subjected to a heat treatment and bending process. The novel razor blade steel has Molybdenum (Mo) content of between about 1.6% to about 5% in weight percent of composition. The razor blade comprises substantially no tempered carbide, tempered carbide of about 0.1 μm or smaller, and substantially no cracks in a bent portion. One embodiment of the novel razor blade steel has a composition comprising, in weight percent, about 0.45% to about 0.55% of C, about 0.4% to about 1.0% of Si, about 0.5% to about 1.0% of Mn, and about 12% to about 14% of Cr, and further includes Mo in an amount of about 2.1% to about 2.8%.

### FIELD OF THE INVENTION

The present invention relates to stainless steel or steel strips used for razor blades and in particular for blades of the bent type.

### BACKGROUND OF THE INVENTION

Razor blades are typically formed of a suitable metallic sheet material such as stainless steel, which is slit to a desired width and heat-treated to harden the metal. The hardening operation utilizes a high temperature furnace, where the metal may be exposed to temperatures greater than 1000° C., followed by quenching. After hardening, a cutting edge is formed on an elongated edge of the blade. The cutting edge typically has a wedge-shaped configuration with an ultimate tip having a radius less than about 1000 angstroms, e.g., about 200-300 angstroms.

The razor blades are generally mounted on a plastic housing (e.g., a cartridge for a shaving razor) or on a bent metal support that is attached to a housing. The razor blade assembly may include a planar blade attached (e.g., welded) to a bent metal support. The blade may include a tapered region that terminates in a sharpened cutting edge. This type of assembly is secured to shaving razors (e.g., to cartridges for shaving razors) to enable users to cut hair (e.g., facial hair) with the cutting edge. The bent metal support may provide the relatively delicate blade with sufficient support to withstand forces applied to blade during the shaving process. Examples of razor cartridges having supported blades are shown in U.S. Pat. No. 4,378,634 and in U.S. Pat. No. 7,131,202, which are incorporated by reference herein.

The performance and commercial success of a razor cartridge is a balance of many factors and characteristics that include rinse-ability (i.e., the ability of the user to be able to easily rinse cut hair and skin particles and other shaving debris from the razor cartridge and especially from between adjacent razor blades or razor blade structures). The distance between consecutive cutting edges or so-called “span” is theorized to affect the shaving process in several ways. The span between cutting edges may control the degree to which skin will bulge between blades, with smaller spans resulting in less skin bulge and more skin comfort during shaving, but may also increase opportunities for double engagement. Larger spans may reduce opportunities for double engagements, but may result in more skin bulge between cutting edges and less skin comfort. The span between cutting edges and, thus between blades, may affect rinsing of shave preparations and shave debris after a shaving stroke, with larger spans easing or quickening rinsing and smaller spans slowing or making rinsing more difficult. A razor cartridge including a razor blade having a bent portion can have certain advantages, such as decreased manufacturing costs and improved rinsability.

The manufacture of commercially acceptable razor cartridges, having one or more bent blades, presents issues such as failure of the blade during manufacturing or even during shaving. Various bent blade designs have been suggested in the literature; however, these designs often result in failure in certain types of steel (e.g., the blades crack or fracture during bending). WO 2012/006043, incorporated herein by reference, discloses a bending process applied to a razor blade for a razor cartridge but describes a problem that the blade is cracked or fractured during the bending process.

A martensitic stainless steel has been widely used for cutlery, surgical knives, and razor blade applications because it has high hardness and good corrosion resistance. Particularly, a high-carbon martensitic stainless steel strip material containing Cr in an amount of about 13% by mass is most commonly used as a material for razor blades. One example is found in JP-A-5-117805 which discloses a steel alloy containing, in weight percent, 0.45 to 0.55% of C, 0.4 to 1.0% of Si, 0.5 to 1.0% of Mn, 12 to 14% of Cr, and 1.0 to 1.6% of Mo, with the balance made up of Fe and unavoidable impurities. This martensitic stainless steel alloy for a razor blade exhibits both high corrosion resistance and high hardness. However, inevitably the resultant high brittleness in this steel results in cracking and fracturing in shapes other than flat blades.

Accordingly, one solution is to alter the geometry of the bent blade, but this compromise to prevent failure (e.g., with a bent portion having a larger radius) may result in decreased rinsability in multi-bladed razor systems. Alternatively, a softer steel may be used to achieve a desired bend radius; however, this also has drawbacks. Blades manufactured from softer steels often do not have the necessary edge strength for a durable cutting edge for a close and comfortable shave.

Thus, a stainless steel (e.g., martensitic) for a razor blade is desired that exhibits high hardness and resistance to corrosion, but with decreased cracking so as to not compromise the robustness of the razor blade and shaving attributes.

### SUMMARY OF THE INVENTION

The present invention relates to a razor blade formed of a substrate, the substrate comprising an amount of Molybdenum (Mo) ranging from about 1.6% to about 5% by weight of composition. The razor blade further comprises a bent portion in a bend zone. The bent portion of the razor blade comprises substantially no cracks, substantially no tempered carbides (M₃C), or tempered carbides of about 0.1 μm or smaller in diameter.

The razor blade further comprises an amount of Carbon (C) ranging from about 0.45 to about 0.55% by weight percent of composition, an amount of Chromium (Cr) ranging from about 12 to about 14% by weight percent of composition, an amount of Silicon (Si) ranging from about 0.4 to about 1.0%, an amount of Manganese (Mn) ranging from about 0.5 to about 1.0%, with the balance in weight percent of composition made up of an amount of Iron (Fe) and unavoidable impurities, or any combination thereof.

The present invention relates to an amount of Molybenum (Mo) from about 2.1% to about 2.8% by weight of composition. The substrate of the present invention is a martensitic stainless steel.

A further aspect of the present invention is a peak breaking angle ranging from about degrees to about 130 degrees, a ductility test breaking angle ranging from about 77 degrees to about 81 degrees, and a blade breaking energy is about 6 millijoules.

Still further, the razor blade of the present invention has an inner radius in said bend zone ranging from about 0.20 mm to about 0.50 mm, a bend angle formed in said bend zone ranging from about 35 degrees to about 75 degrees, a thickness of said razor blade ranging from about 0.05 mm to about 0.15 mm, and a ratio of said inner radius to a thickness of said razor blade ranges from about 1 to about 10.

The present invention relates to a razor cartridge comprising a plurality of razor blades, wherein at least one of said plurality of razor blades is formed of a substrate comprising an amount of Molybdenum ranging from about 1.6% to about 5% by weight of composition.

The present invention relates to a method of manufacturing a razor blade comprising the steps of: providing at least one strip of a steel substrate, said substrate comprising an amount of Mo ranging from about 1.6% to about 5% by weight of composition, heat treating the at least one steel strip, tempering the at least one steel strip, and bending a portion of the at least one steel strip forming a bend zone in the portion. The method comprises a razor blade steel strip with substantially no tempered carbides (M₃C) present after the heat treating step. The method comprises a razor blade steel strip with substantially no cracks generated in the bent portion after the bending step. The method comprises a razor blade steel with an amount of Carbon (C) ranging from about 0.45 to about 0.55% by weight percent of composition, an amount of Chromium (Cr) ranging from about 12 to about 14% by weight percent of composition, an amount of Silicon (Si) ranging from about 0.4 to about 1.0%, an amount of Manganese (Mn) ranging from about 0.5 to about 1.0%, with the balance in weight percent made up of Iron (Fe) and unavoidable impurities or any combination thereof.

### BRIEF DESCRIPTION OF THE DRAWINGS

While the specification concludes with claims particularly pointing out and distinctly claiming the subject matter which is regarded as forming the present invention, it is believed that the invention will be better understood from the following description which is taken in conjunction with the accompanying drawings in which like designations are used to designate substantially identical elements, and in which:

FIG. 1 is a diagram of a razor blade of the bent type of the present invention.

FIG. 1A is a close-up view of the bend portion and bend zone of the razor blade of FIG. 1.

FIG. 2A is an electron micrograph showing the metal structure of the steel of a razor blade of the prior art after heat treatment.

FIG. 2B is an electron micrograph showing the metal surface of the steel of a razor blade of the prior art of FIG. 2A after a bending process.

FIG. 2C is an electron micrograph showing the metal surface of the steel of a razor blade of the prior art after both heat treatment and bending process.

FIG. 3A is an electron micrograph showing the metal structure of the steel of a razor blade of the present invention after heat treatment.

FIG. 3B is an electron micrograph showing the metal surface of the steel of a razor blade of the present invention of FIG. 3A after a bending process.

FIG. 3C is a electron micrograph showing the metal surface of the steel of a razor blade of the present invention after both heat treatment and bending process.

FIG. 4A is an electron micrograph showing the metal structure of the steel of a razor blade of another embodiment of the present invention after heat treatment.

FIG. 4B is an electron micrograph showing the metal surface of the steel of a razor blade of another embodiment of the present invention after a bending process.

FIG. 4C is an electron micrograph showing the metal surface of the steel of a razor blade of another embodiment of the present invention after both heat treatment and bending process.

FIG. 5 is a graph depicting the ductility test breaking angle of the razor blades of FIGS. 2C, 3C, and 4C.

FIG. 6 is a graph depicting the blade breaking energy of the razor blades of FIGS. 2C, 3C, and 4C.

FIG. 7 is a top view of a razor cartridge of the present invention.

FIG. 8 is a flow chart of the present invention process of forming a razor blade of the present invention.

### DETAILED DESCRIPTION OF THE INVENTION

The novel stainless steel of a razor blade substrate of the present invention has a higher Molybdenum (Mo) content, of up to 5%, over conventional steel.

While it is generally known that the presence of Molybdenum (Mo) in steel substrates significantly increases the resistance to both uniform and localized corrosion and assists with increasing hardness, the present invention steel composition for a razor blade, with its increased Mo content, also surprisingly provides for improved ductility in the steel which in turn has a unexpected effect of suppressing the formation of cracks in the steel, a benefit for bent blades.

Increasing ductility or softness, as mentioned above in the Background of the Invention section, is generally not desired in the prior art since softer steel compositions often do not have the necessary edge strength for a close and comfortable shave.

Just as it was not known in the prior art that the ductility of a steel could be improved by increasing Mo, it was also not known in the prior art that increasing Mo has the affect of decreasing tempered carbide (M₃C) formation. In the application to the razor blade bending process, as will be explained below, an increased amount of Mo in the steel reduces cracks in the razor blade when forming razor blades of the bent type.

The present invention was realized by focusing on the relationship between the state of the cracks formed on the surface of the steel and the metal structure of the blade steel substrate itself after heat treatment (e.g., quenching and tempering).

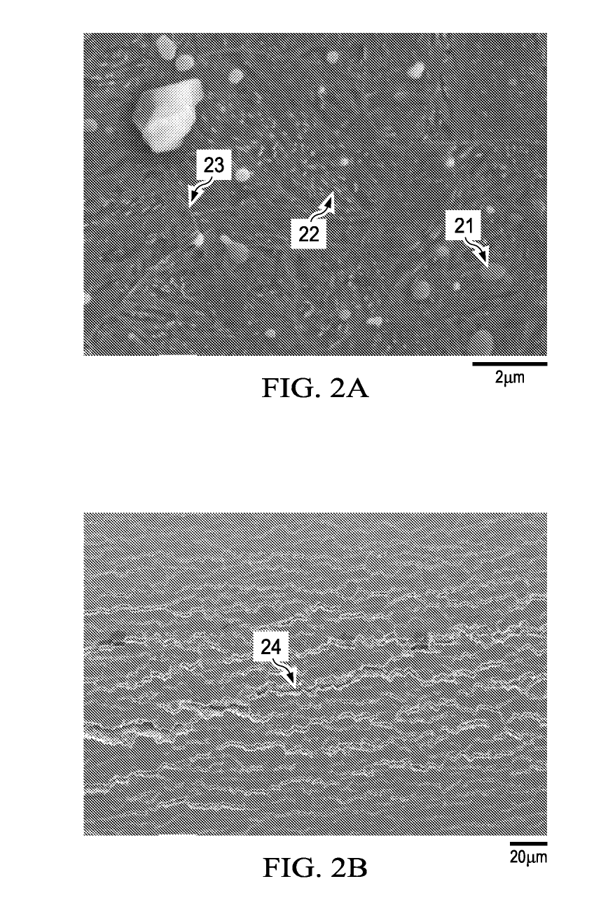

After heat treatment of razor blades, it was realized that the amount of formed M₃C (tempered carbide) deposited on a crystal grain boundary, as shown below in FIGS. 2A, 3A, and 4A, has a direct effect on the formation of cracks that are generated in a bent portion of a bend zone after the bending process, as shown respectively in FIGS. 2B, 2C, 3B, 3C, 4B, and 4C.

The bending workability or ductility of the steel material, after quenching and tempering, it was determined, can be improved by modifying the steel composition so as to decrease the amount of M₃C formed at the crystal grain boundary.

It was found that increasing Mo in turn decreased the carbide precipitation (M₃C) and surprisingly improved the ductility of the steel without compromising its high hardness and mechanical strength. In particular, with Mo content larger than 1.6%, and preferably with Mo larger than 2.1%, the Mo desirably suppresses tempered carbide (M₃C formation) and reduces the size of the tempered carbide to 0.1 μm or smaller during heat treatment processes. It was realized that Molybdenum (Mo), being an element that is capable of forming carbide on its own, is hardly dissolved in M₃C, where M is a metal element such as Fe, Cr or Mo.

The present invention is directed to a strip of a steel substrate for razor blades, which has a composition containing, in weight percent, of Mo in an amount between about 1.6% to about 5.0%.

In one specific embodiment, the present invention has a stainless steel composition in weight percent of 0.45% to 0.55% of C, 0.4% to 1.0% of Si, 0.5% to 1.0% of Mn, and 12% to 14% of Cr, and further contains Mo, with the balance made up of Fe and unavoidable impurities, or any combination thereof, wherein Mo is contained in an amount between about 1.6% to about 5.0% and more preferably, in an amount between about 2.1% to about 2.8%.

While the embodiments of the present invention focus on compositions with the above elements for practical purposes, the present invention contemplates that the elements, with the exception of the Mo, may be modified in amount, type, and in weight percent. For instance, the substrate may comprise substantially only C, Cr, and Si, in addition to the Mo within the novel range of 1.6% to 5%.

The term “ductility” or “ductile” as used herein signifies the ability of a material to deform plastically before fracturing or cracking. Ductile materials may be malleable or easily molded or shaped. A bending process with a bend-to-fail type instrument can generally be used to assess the ductility of razor blade steel by measuring values for the peak breaking angle and the amount of energy it takes to break or bend the steel blade.

The term “crack” as used herein can be understood as signifying a “macro crack” or a “micro crack.” While a “macro” crack generally refers to a type of crack that is visible with the naked eye or with low magnification, usually about 50× but not to exceed 100×, a “micro” crack generally refers to a crack that can only be seen under a high magnification, generally greater than 100× or 200×. A macro crack may also tend to be longer and extend deeper into a substrate when compared to a micro crack.

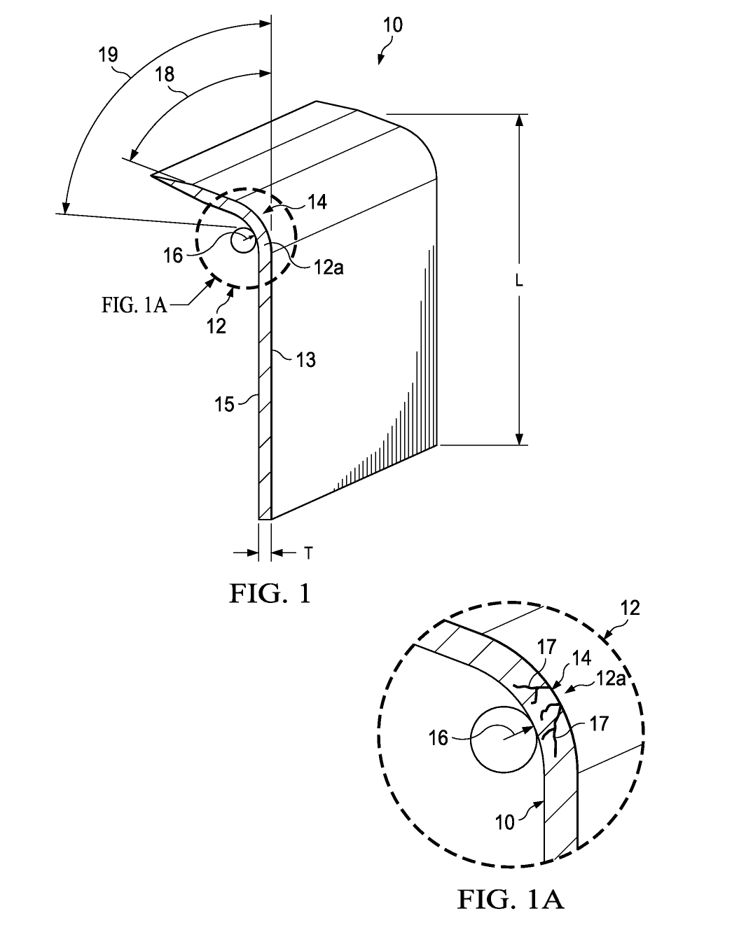

The peak breaking angle and further description of a blade of the bent type is shown in FIG. 1. In FIG. 1, a razor blade 10 is depicted having a bend zone 12. Bend zone 12 is the area around the bent portion 12a of the razor blade as shown. Bend zone 12 includes a tensile surface 14 on the outer surface 13 of the razor blade 10, and inner radius 16, and may include cracks or fractures 17. On the inner surface 15 of the razor blade 10, an inner radius 16 is generally formed, preferably ranging from about 0.20 mm to about 0.50 mm, and more preferably the inner radius is about 0.33 mm.

While no crack is generally seen at the macro scale (e.g., “macro” crack) during formation of the razor blade 10, one or more cracks or fractures 17 (e.g., “micro” cracks) would likely be visible when the tensile surface is examined using SEM at high magnification. These cracks 17, which are sometimes referred to as fractures, are shown illustratively in FIG. 1A and would generally form when the bending process is performed on a steel strip (after quenching and tempering steps). These cracks and/or fractures are generally first formed on the outer surface or circumferential side of a bent portion in the bend zone and would likely extend, in the thickness direction, from the tensile surface away and toward the inner surface of the razor blade as shown. Finally, if the cracks are too big or too deep, the steel strip may be broken.

The razor blade 10 is formed to have a bend angle 18, desirably ranging from about 35 to about 75 degrees, preferably about 70 degrees, to provide a close and comfortable shave. The ductility of the razor blade is determined with a breaking angle or a peak breaking angle 19. The peak breaking angle 19 of the present invention may range from 0 degrees to 130 degrees, generally between about 60 degrees to about 130 degrees, preferably about 90 degrees, and more preferably about 68.5 to 80 degrees. It should be noted that the peak breaking angle 19 is generally larger than the bend angle 18 since it represents the angle at which a test razor blade would break.

An effective thickness T of the razor blade of the present invention including a razor blade of the bent type shown in FIG. 1 sufficient for withstanding the bending process is preferably about 0.05 mm to about 0.15 mm, preferably about 0.068 mm to about 0.080 mm, and more preferably about 0.074 mm. Blade steel may generally be desirably thinner so as to assist in the bending process (e.g., reduce strain or the amount of stretching at the tensile surface).

The bent razor blade has a length L of about 2.7 mm to about 3.2 mm and preferably about 2.84 mm.

Desirably, the ratio of the inner radius 16 to the thickness T of the blade of the present invention ranges from about 1 to about 10. For instance, a razor blade of the present invention having an inner radius of 0.33 mm and a thickness T of 0.074 mm has a ratio of 4.46.

Table 1 lists the chemical compositions of prior art martensitic stainless steel and an example martensitic stainless steel of the present invention. As noted below in Table 1, the novel Mo content of the present invention is between about 1.6 and about 5.0% by weight percentage of the composition.

TABLE 1
Steel Chemical Composition Comparison

| | Prior art | Present Invention |
|---|---|---|
| Steel Element | (weight percent) | (weight percent) |
| Carbon (C) | 0.45-0.55 | 0.45-0.55 |
| Chromium (Cr) | 12-14 | 13.62 |
| Molybdenum (Mo) | 1.0-1.6 | 1.6-5.0 |
| Silicon (Si) | 0.50 | 0.4-1.0 |
| Manganese (Mn) | 0.89 | 0.5-1.0 |
| Iron (Fe) and | Balance | Balance |
| unavoidable impurities | | |

The rational for the various elements shown above and their ranges in the present invention are as follows:

Content of Molybdenum (Mo): about 1.6% to about 5.0%

The content of Mo is desired to be 1.6% or more in weight percent so as to decrease the formation of tempered carbides (M₃C) and also to obtain an effect of miniaturizing the size of the tempered carbide. This is because Mo is one of the elements capable of forming a carbide of its own, and has properties that it is hardly dissolved in M₃C. In a tempering temperature range, M₃C is generated due to the diffusion of only Carbon (C). However, it is considered that when a specific amount of Mo is present in a base, Mo prevents M₃C from aggregating or increasing its size (e.g., Mo miniaturizes M₃C).

When the lower limit content of Mo of the present invention is about 1.6% or greater, (e.g., about 1.8%, about 2.1%, about 2.3%), almost no M₃C having a size of 0.1 μm or greater is observed on the tensile surface 14 of the razor blade. For instance, this is shown clearly in FIG. 2B showing a heat treated surface of Mo content of about 2.3%.

This M₃C deposited by tempering has a higher hardness than a martensite matrix, and therefore, when bending stress is applied to a razor blade, due to a difference in hardness between M₃C and the martensite matrix, a crack is liable to occur at the boundary between M₃C and a martensite matrix. M₃C continues to be deposited in a grain or along a crystal grain boundary. Such M₃c formed at the boundary is liable to be an origin from which the cracks formed during the bending process may extend. A decrease in the content of M₃C at the boundary is thus advantageous to the suppression of crack formation.

Depending on the other elements present in the substrate composition and their respective weight percents, if the content of Mo is increased beyond an upper limit, deformation resistance may also be increased which may deteriorate the bending workability of the steel. Thus, an upper limit for Mo may be set at about 5%, preferably at about 3.5%, and most preferably about 2.8%.

Content of Carbon (C): about 0.45% to about 0.55%

With a content of C in the range from about 0.45 to about 0.55% a sufficient hardness for razor blades is achieved while also suppressing the crystallization of eutectic carbides during casting or solidification to the minimum. If the content of C is less than 0.45%, a sufficient hardness for a razor blade generally cannot be obtained. On the other hand, if the content of C exceeds 0.55%, the amount of crystallized eutectic carbides is increased depending on the balance with the amount of Cr which may cause a chip in the razor blade during sharpening processes. For this reason, the content of C preferably ranges from about 0.45% to about 0.55%. For achieving the above-described effect of C, a preferred lower limit of the content of C is 0.48% and the preferred upper limit of the content of C is 0.52%.

Content of Silicon (Si): about 0.2% to about 1.0%

Si is added to a steel substrate as a deoxidizing agent during refinement. In order to obtain a sufficient deoxidizing effect, the residual amount of Si is generally 0.2% or more. On the other hand, if the content of Si exceeds 1.0%, the amount of inclusions increases which may undesirably cause one or more chips in the razor blade during sharpening. Accordingly, the content of Si ranges desirably from about 0.2% to 1.0%. A preferred lower limit of the content of Si is 0.40% and the preferred upper limit of the content of Si is 0.60%.

Content of Manganese (Mn): about 0.2% to about 1.0%

Mn is also added as a deoxidizing agent during refinement in the same manner as Si. In order to obtain a sufficient deoxidizing effect, the residual amount of Mn is about 0.2% or more. On the other hand, if the content of Mn exceeds 1.0%, the hot workability of the razor blade substrate may begin deteriorating. Accordingly, the content of Mn ranges desirably from about 0.2% to about 1.0%. A preferred lower limit of the content of Mn is 0.60% and the preferred upper limit of the content of Mn is 0.90%.

Chromium (Cr): about 12% to about 14%

The reason why the content of Cr is desirably set from about 12% to about 14% is to achieve sufficient corrosion resistance and also to suppress the crystallization of eutectic carbides during casting or solidification to the minimum. If the content of Cr is less than 12%, sufficient corrosion resistance in stainless steel cannot be obtained. On the other hand, if the content of Cr exceeds 14%, the amount of crystallized eutectic carbides is increased to cause a chip in the razor blade when sharpening the razor blade. For this reason, the content of Cr is set to 12% to 14%. For achieving the above-described effect of Cr, the preferred lower limit of the content of Cr is 13.2% and the preferred upper limit of the content of Cr is 14%.

The balance of a specific composition of the present invention, other than the elements described above, may be made up of Iron (Fe) and other impurities. Examples of representative impurity elements include Phosphorus (P), Sulfur (S), Nickel (Ni), Vanadium (V), Copper (Cu), Aluminum (Al), Titanium (Ti), Nitrogen (N), and Oxygen (O). These elements may generally be unavoidably mixed therein, however, it is desirable to regulate these impurities within the following ranges so as to not impair the effects of the present invention: P≦0.03%, S≦0.005%, Ni≦0.15%, V≦0.2%, Cu≦0.1%, Al≦0.01%, Ti≦0.01%, N≦0.05%, and O≦0.05%.

A martensitic stainless steel of the present invention was tested for razor blade applications, and in particular razor blades of the bent type were formed and tested. Table 2 below lists the composition of a prior art razor blade steel substrate (A) and two novel razor blades having steel substrates (B) and (C) of the present invention, both within the novel Mo content range. Embodiment #1 (steel B) comprises a Mo content of about 2.31% and Embodiment #2 (steel C) comprises a Mo content of 2.61% in weight percent.

TABLE 2
Embodiments of the present invention

| | A | B | C |
|---|---|---|---|
| | Prior Art | Present Invention | Present Invention |
| | Steel | Steel | Steel |
| Steel | Example | Embodiment #1 | Embodiment #2 |
| Element | (weight percent) | (weight percent) | (weight percent) |
| Carbon (C) | 0.50 | 0.50 | 0.50 |
| Chromium (Cr) | 13.50 | 13.62 | 13.57 |
| Molybdenum | 1.30 | 2.31 | 2.61 |
| (Mo) | | | |
| Silicon (Si) | 0.50 | 0.45 | 0.46 |
| Manganese | 0.89 | 0.87 | 0.87 |
| (Mn) | | | |
| Iron (Fe) and | Balance | Balance | Balance |
| unavoidable | | | |
| impurities | | | |

Each of the types of steel substrates used for the razor blades in Table 2 undergoes heat treatment and blade bending processes.

The heat treatment of the blade strip comprises hardening in an inline furnace, going through many steps such as austenization, quenching and tempering processes. Thus, high hardness is achieved for each of razor blade steel substrate types A, B, and C. Heat treatment generally may include quenching to 1100° C. for 40 seconds, quenching to room temperature, a cryogenic treatment at −75° C. for 30 minutes, and tempering at 350° C. for 30 minutes.

Heat treatment conditions may be specially selected for ductility evaluations. For example, U.S. Patent Publication No. 2007/0124939 and U.S. Pat. No. 8,011,104 disclose methods of locally heat treating a portion of a hardened razor blade body to enhance ductility for facilitating formation of a bent portion. A localized heat treatment or scoring processes can be used with the present invention method if desired.

As can be seen from Table 3, the hardness for each of the razor blades steel substrate types, A, B, and C formed is generally within the same range.

TABLE 3
Vicker hardness (HV) of the steels A, B, and C as hardened

| | Vicker Hardness (HV) | | |
|---|---|---|---|
| | A | B | C |
| | Prior Art | Present Invention | Present Invention |
| | Steel | Steel | Steel |
| | Example | Embodiment #1 | Embodiment #2 |
| | (weight percent) | (weight percent) | (weight percent) |
| Heat treatment | 736 | 738 | 738 |
| condition #1 | | | |
| Heat treatment | 709 | 711 | 706 |
| condition #2 | | | |

After the blades are heated, hardened, and tempered, the blade bending process formed the blades with a bend having about a 70 degree bending angle and an inner radius of 0.33 mm. While generally no cracks can be seen in any steel blades A, B, or C within macro scale during the forming of the bend, the tensile surface of the bend zone of each is examined using a scanning electron microscope at high magnification as will be shown and described below.

Referring now to FIG. 2A, a scanning electron micrograph (SEM) at a magnification of 10000× depicting a portion of a tensile surface 21 of the type of metal substrate of razor blade A from Table 2 having a prior art Mo content of about 1.3% after undergoing a heat treatment process is shown.

A carbide having a spherical shape or a size exceeding 0.2 μm seen in FIG. 2A is considered a primary carbide 21.

Additionally, as shown in FIG. 2A, a white fine M₃C type carbide is also present in two different states, one finely dispersed in a crystal grain 22 and one disposed along a crystal grain boundary 23. The size of this carbide is less than about 0.1 μm.

Subsequently, a bending test at about 90 degrees was performed on razor blade with steel substrate A having an amount of Mo in the prior art range of about 1.30%. Using a scanning electron microscope, the presence or absence of any type of crack can generally be observed on a tensile surface from directly above the bent portion.

Referring now to FIG. 2B, the resultant scanning electron microscope at 500× magnification of the tensile surface of bent portion of steel substrate A is shown where many cracks (24) are observed. The cracks (24) may be described as lengthy, wide, and somewhat deep and thus, generally undesirable for razor blade applications.

FIG. 2C depicts a scanning electron micrograph at 5000× showing a portion of the tensile surface 25 of the bent portion in the bend zone of a razor blade of the metal substrate of razor blade A from Table 2 after undergoing both heat treatment and bending processes of the type mentioned above where the bend angle is about 70 degrees.

As can be seen, several micro cracks 26, some of which are deep, are present. M₃C carbides 27, as best can be seen, are generally dispersed along a crystal grain boundary 28 of crystal grains 29 forming a network 27a in steel A and their presence is reduced after the bending process is performed.

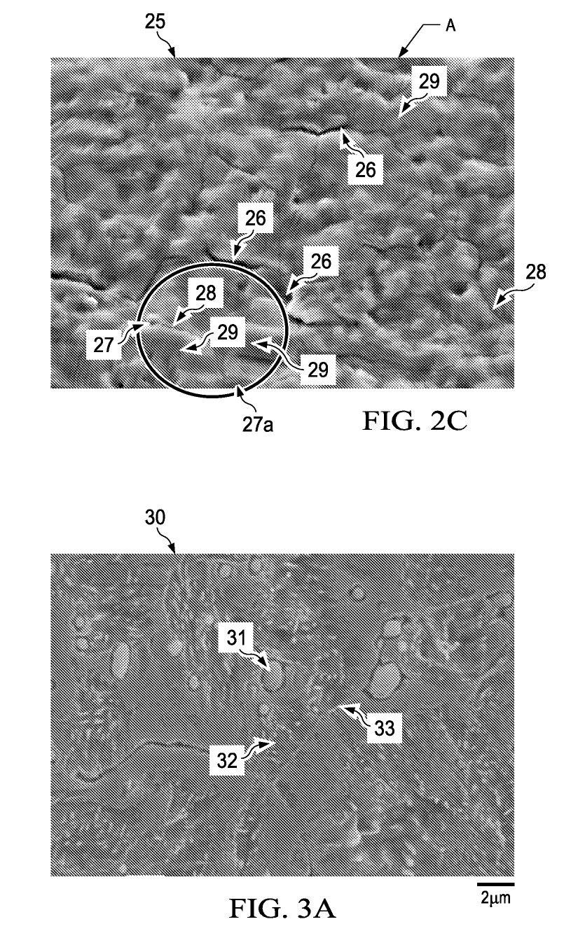

Referring now to FIG. 3A, a scanning electron micrograph at a magnification of 10000× depicting a portion of a tensile surface 30 of the type of metal substrate of razor blade B from Table 2 having the present invention Mo content of about 2.3% after undergoing heat treatment process is shown.

A carbide having a spherical shape or a size exceeding 0.2 μm seen in FIG. 3A is considered a primary carbide (31). Additionally, as shown in FIG. 3A, a carbide of the M₃C type, a white fine M₃C carbide, is present in two different states, one finely dispersed in a crystal grain (32) and one disposed along a crystal grain boundary (33). However, as the amount of Mo has increased, the amount of M₃C appears to have decreased in FIG. 3A as compared to FIG. 2A, as the size thereof is also somewhat miniaturized.

Subsequently, a bending test at about 90 degrees was performed on razor blade with steel substrate B having an amount of Mo of about 2.31%. Using a scanning electron microscope, the presence or absence of a crack can generally be observed on a tensile surface from directly above the bent portion.

Referring now to FIG. 3B, the resultant scanning electron microscope at a magnification of 500× of the tensile surface of bent portion of steel substrate A is shown where many micro cracks 34 are observed. Though present, cracks 34 of the present invention appear to be much smaller, shallower and less wide than cracks 24 of FIG. 2B.

FIG. 3C is an electron micrograph at 5000× showing a portion of the tensile surface 35 of the bent portion in the bend zone of the metal structure of the razor blade substrate of type B from Table 2 after undergoing both heat treatment and bending processes of the type mentioned above where the bend angle is about 70 degrees. Steel strip B has a novel Mo content of about 2.31%.

As can be seen, there are substantially no cracks (or a negligible amount of cracks) visible in steel B of FIG. 3C having the higher novel Mo content of 2.31% than in FIG. 2C with the steel A having the lower prior art Mo content of 1.3%. The tensile surface 35 of FIG. 3C appears smoother than that of tensile surface 25 in FIG. 2C depicting Steel A. The appearance of smoothness may generally be attributed to the fact that the surface contains a reduced amount of imperfections, such as cracks, boundaries, roughness, or other irregularities.

While M₃C carbides are generally dispersed along a crystal grain boundary of crystal grains forming a network in steel B, there are substantially no M₃C carbides readily found in the tensile surface 35 shown. This may be attributed to the bend angle of the steel B being lower than that of steel A shown in FIG. 3B.

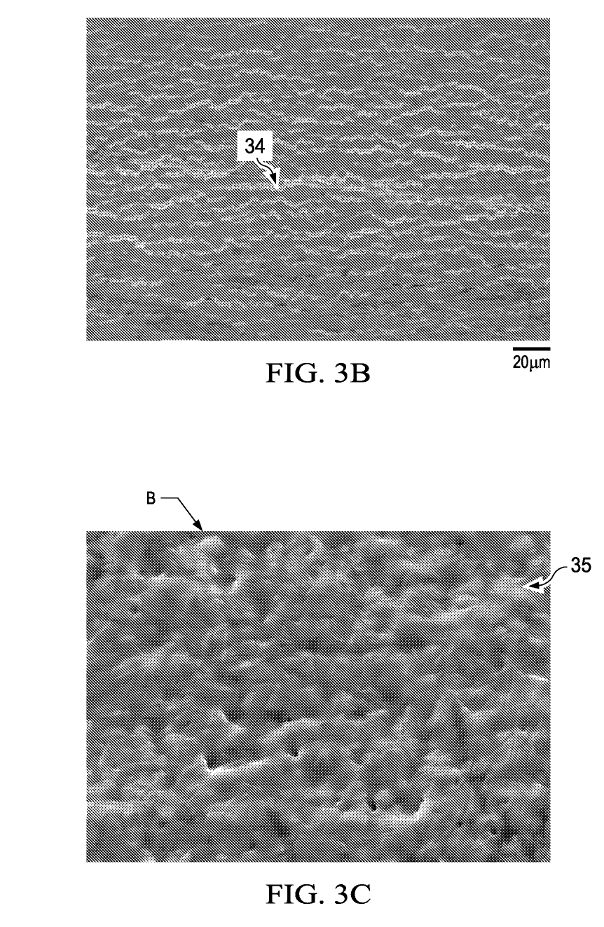

FIG. 4A depicts a scanning electron micrograph at a magnification of 10000× depicting a portion of a tensile surface 40 of the bent portion in the bend zone of the metal structure of razor blade of steel substrate of type C from Table 2 after undergoing heat treatment process. Steel substrate C has a novel Mo content of 2.61%. As shown in FIG. 4A, while there are primary carbides (41) present, there are no M₃C carbides observed.

Subsequently, a bending test at about 90 degrees was performed on razor blade with steel substrate C having an amount of Mo of about 2.61%. As noted, using a scanning electron microscope, the presence or absence of a crack can generally be observed on a tensile surface from directly above the bent portion. Where no M₃C carbides were observed after heat treatment as shown in FIG. 4A, the resultant scanning electron microscope at a magnification of 500× of the tensile surface 42 of bent portion of steel substrate A shown in FIG. 4B, no cracks are generated. This is desirable, as with no cracks, the razor blade is less likely to break.

FIG. 4C is an electron micrograph at a magnification of 5000× showing a portion of the tensile surface 44 of the bent portion in the bend zone of the metal structure of steel strip C from Table 2 after undergoing both heat treatment and bending processes as mentioned above where the bend angle is about 70 degrees, slightly less than the 90 degree bend angle of FIGS. 4A and 4B. Steel strip C has a novel Mo content of 2.61%. Again, there are no cracks generated in Steel C. The tensile surface 44 of FIG. 4C appears smoother than both that of FIGS. 2C and 3C depicting Steel A and Steel B, respectively. The appearance of smoothness may generally be attributed to the fact that the surface contains a reduced amount of imperfections, such as cracks, boundaries, roughness, or other irregularities.

It is apparent that, as the amount of Mo was increased, the cracks in a bent portion in a bend zone of a razor blade became shallower or begin to disappear. From this testing, it was found that cracks were preferentially formed from M₃C deposited along the grain boundary during the bending process. When the amount of Mo was increased, M₃C at the grain boundary was decreased, thereby suppressing the formation of cracks.

Unlike prior art steel A (FIGS. 2A-2C), both novel steel blade B (FIG. 3A-3C) and novel steel blade C (FIG. 4A-4C) show no grain boundary cracking under the same heat treatment and bending conditions. This indicates that novel steel blades types B and C can tolerate higher strain, are more ductile and have better bending formability than steel blade type A, while still maintaining high hardness for razor blades and shaving applications.

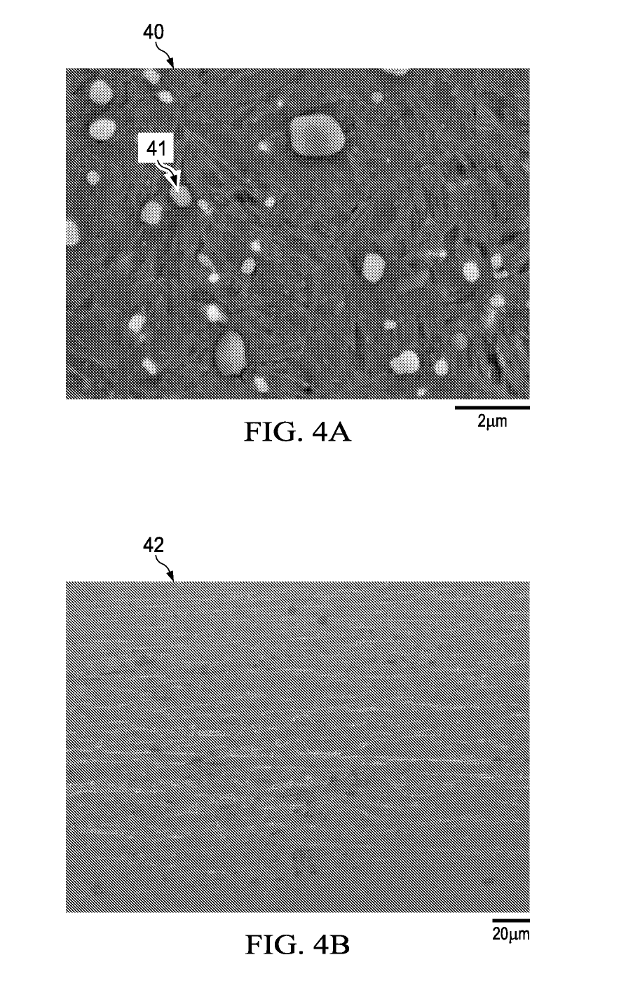

The graph shown in FIG. 5 depicts the improvement seen in steel blades B and C in tolerating higher strains, improved ductility, and bending formability over steel blade A. For instance, steel blade A is shown in FIG. 5 as having a resulting ductility test breaking angle 52 of about 74 degrees to about 75 degrees and under the same heat treatment conditions, steel blade B has a ductility test breaking angle 54 of about 77 degrees to about 78 degrees, while steel blade C (with Mo content greater than that of both steel blade A and steel blade B) has a ductility test breaking angle 56 of between 79 degrees and 81 degrees. Thus, in these embodiments, novel steel razor blades B and C have a ductility test breaking angle on average of about 77 degrees to about 81 degrees which is greater than the ductility test breaking angle of steel blade A of about 74 degrees.

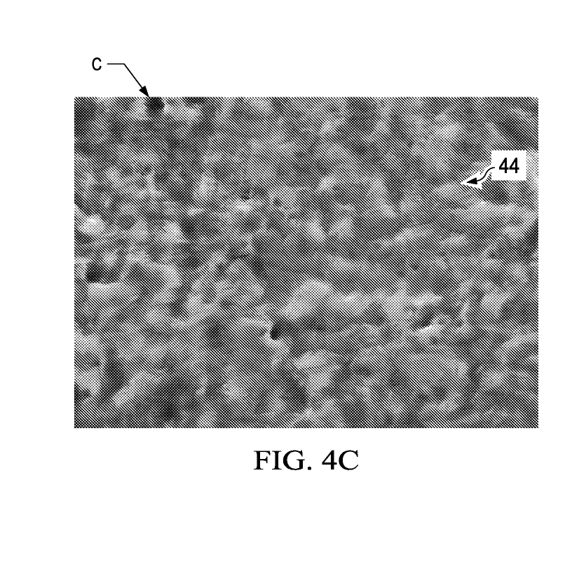

The graph shown in FIG. 6 depicts the improvement seen in steel blades B and C in the breaking energy required at the breaking angle point. The higher breaking energy indicates that the material is more ductile, and is thus able to tolerate higher strains with improved bending formability.

For instance, steel blade A is shown in FIG. 6 as having a blade breaking energy 62 a little over 4 millijoules and under the same heat treatment conditions, steel blade B has a blade breaking energy 64 of a little over 6 millijoules, while steel blade C (with Mo content greater than that of both steel blade A and steel blade B) has a blade breaking energy 66 of just under 6 millijoules.

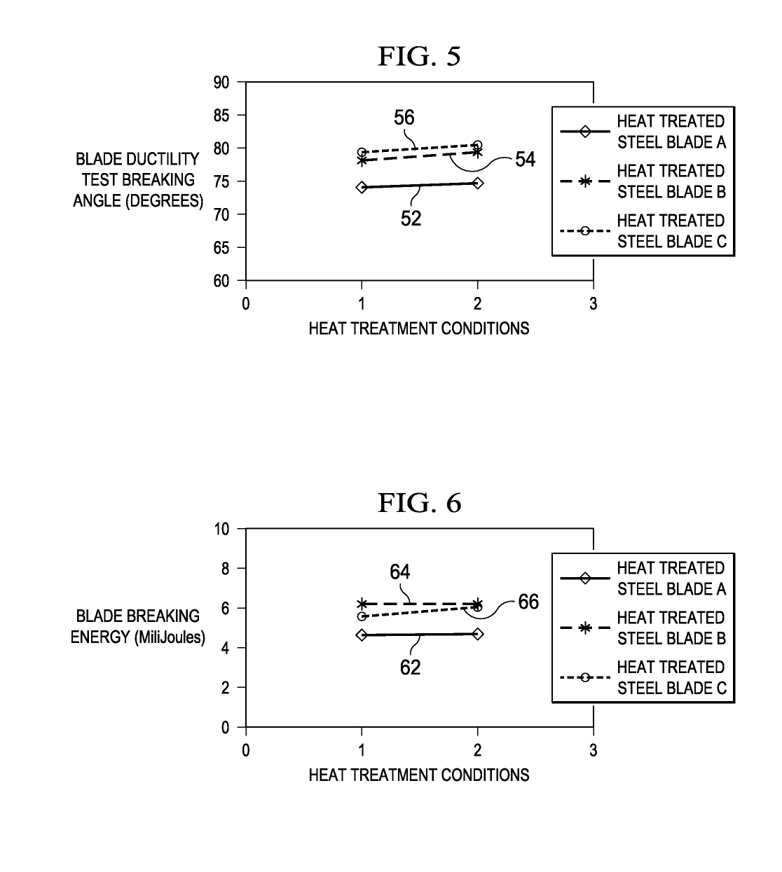

As shown in FIG. 7, a razor cartridge 70 comprises razor blades 72 of the present invention where one or more of the razor blades have novel Mo content in the range of about 1.6% to about 5%. The blade 72 may preferably be of the bent type but it may also be a blade-supported type blade.

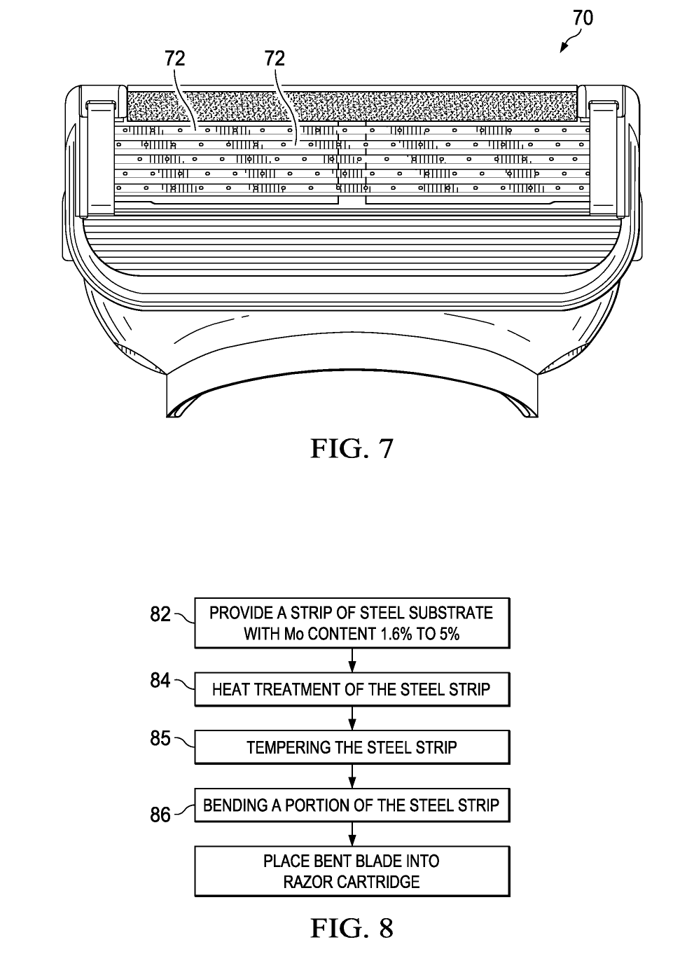

FIG. 8 outlines the process steps of forming the razor blade 72 of the present invention. A first step 82 is a step of providing at least one strip of a steel substrate, where the substrate has an amount of Mo ranging from about 1.6% to about 5% by weight of composition.

At second step 84 and third step 85 a heat treating and tempering of the at least one steel strip with conditions described above occurs, respectively. A fourth step 86 is a step of bending a portion of the at least one steel strip forming a bend zone in that portion.

There are substantially no tempered carbides (M₃C) present after step 84. There are substantially no cracks generated in said bend zone after step 86.

The razor blade steel substrate further includes an amount of Carbon (C) ranging from about 0.45% to about 0.55% by weight percent of composition, an amount of Chromium (Cr) ranging from about 12% to about 14% by weight percent of composition, an amount of Silicon (Si) ranging from about 0.4% to about 1.0%, an amount of Manganese (Mn) ranging from about 0.5% to about 1.0%, with the balance in weight percent made up of Iron (Fe) and unavoidable impurities or any combination thereof.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A razor blade formed of a substrate, the substrate comprising an amount of Molybdenum (Mo) ranging from about 1.6% to about 5% by weight of composition.

2. The razor blade of claim 1 further comprises a bent portion in a bend zone.

3. The razor blade of claim 2 wherein said bent portion further comprises substantially no cracks.

4. The razor blade of claim 2 wherein said bent portion comprises substantially no tempered carbides (M₃C).

5. The razor blade of claim 2 wherein said bent portion comprises tempered carbide of about 0.1 μm or smaller in diameter.

6. The razor blade of claim 1 further comprises an amount of Carbon (C) ranging from about 0.45% to about 0.55% by weight percent of composition.

7. The razor blade of claim 1 further comprises an amount of Chromium (Cr) ranging from about 12% to about 14% by weight percent of composition.

8. The razor blade of claim 1 further comprising an amount of Silicon (Si) ranging from about 0.4% to about 1.0%, an amount of Manganese (Mn) ranging from about 0.5% to about 1.0%, with the balance in weight percent of composition made up of an amount of Iron (Fe) and unavoidable impurities, or any combination thereof.

9. The razor blade of claim 1 wherein said amount of Molybenum (Mo) ranges from about 2.1% to about 2.8% by weight of composition.

10. The razor blade of claim 1 wherein said substrate is a martensitic stainless steel.

11. The razor blade of claim 1 wherein a peak breaking angle ranges from about 0 degrees to about 130 degrees.

12. The razor blade of claim 1 wherein a ductility test breaking angle ranges from about 77 degrees to about 81 degrees.

13. The razor blade of claim 1 wherein a blade breaking energy is about 6 millijoules.

14. The razor blade of claim 2 wherein an inner radius in said bend zone ranges from about 0.20 mm to about 0.50 mm.

15. The razor blade of claim 2 wherein a bend angle formed in said bend zone ranges from about 35 degrees to about 75 degrees.

16. The razor blade of claim 1 wherein a thickness of said razor blade ranges from about 0.05 mm to about 0.15 mm.

17. The razor blade of claim 14 wherein a ratio of said inner radius to a thickness of said razor blade ranges from about 1 to about 10.

18. A razor cartridge comprising a plurality of razor blades, wherein at least one of said plurality of razor blades is formed of a substrate comprising an amount of Molybdenum ranging from about 1.6% to about 5% by weight of composition.

19. A method of manufacturing a razor blade comprising the steps of:
a. providing at least one strip of a steel substrate, said substrate comprising an amount of Mo ranging from about 1.6% to about 5% by weight of composition;
b. heat treating said at least one steel strip;
c. tempering said at least one steel strip; and
d. bending a portion of said at least one steel strip, said bent portion in a bend zone.

20. The method of claim 19 wherein substantially no tempered carbides (M₃C) are present after step (b).

21. The method of claim 19 wherein substantially no cracks are generated in said bent portion after step (d).

22. The method of claim 19 further comprises an amount of Carbon (C) ranging from about 0.45 to about 0.55% by weight percent of composition, an amount of Chromium (Cr) ranging from about 12 to about 14% by weight percent of composition, an amount of Silicon (Si) ranging from about 0.4 to about 1.0%, an amount of Manganese (Mn) ranging from about 0.5 to about 1.0%, with the balance in weight percent made up of Iron (Fe) and unavoidable impurities or any combination thereof.
